(19) United States
(12) Patent Application Publication
(10) Pub. No.: US 2010/0135002 A1
(43) Pub. Date: Jun. 3, 2010

(54) ILLUMINATION SYSTEM FOR ILLUMINATING DISPLAY DEVICES, AND DISPLAY DEVICE COMPRISING SUCH AN ILLUMINATION

(75) Inventors: Peter J. Bremer, Eindhoven (NL); Lex De Rijck, Waalre (NL); Berry Meulendijks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,120

(22) PCT Filed: Aug. 4, 2006
(86) PCT No.: PCT/IB06/52697

§ 371 Date: Feb. 7, 2008

Related U.S. Application Data
(60) Provisional application No. 60/707,191, filed on Aug. 10, 2005.

(51) Int. Cl. G09F 13/04

(52) U.S. Cl. 362/97.1

(57) ABSTRACT

The invention relates to an illumination system (1) for illuminating display devices, comprising: a plurality of fluorescent lamps (2), each fluorescent lamp (2) comprising: an at least partially light-transmissive elongated discharge vessel (3,6) filled with an ionisable substance, and a first electrode (4) and a second electrode (5) connected to said vessel (3,6), between which electrodes (4,5) a discharge extends during lamp operation, wherein the discharge vessels (3,6) of at least two lamps (2) are mutually coupled by means of at least one channel (8), said channel (8) being positioned at a distance of the electrodes (4,5) of said lamps (2). The invention also relates to a display device comprising such an illumination system.

The invention relates to an illumination system for illuminating display devices, comprising: a plurality of fluorescent lamps, each fluorescent lamp comprising: an at least partially light-transmissive elongated discharge vessel filled with an ionisable substance, and a first electrode and a second electrode connected to said vessel, between which electrodes a discharge extends during lamp operation, wherein the discharge vessels of at least two lamps are mutually coupled by means of at least one channel, said channel being positioned at a distance of the electrodes of said lamps. The invention also relates to a display device comprising such an illumination system.

Fluorescent light sources are commonly known and are amongst others applied into illumination systems. Such an illumination system is referred to as a so-called “direct-lit” back light or “direct-under” type of back light illumination system. The illumination systems are used, inter alia, as back or side lighting of (image) display devices, for example for television receivers and monitors. Such illumination systems can particularly suitably be used as a back light for non-emissive displays, such as liquid crystal display devices, also referred to as LCD panels, which are used in (portable) computers or (cordless) telephones. The illumination system is particularly suitable for application in large-screen LCD display devices for television and professional applications.

Said display devices generally include a substrate provided with a regular pattern of pixels, which are each driven by at least one electrode. In order to reproduce an image or a datagraphic representation in a relevant area of a (display) screen of the (image) display device, the display device employs a control circuit. In particular, in an LCD device, the light originating from the back light is modulated by means of a switch or a modulator, while applying various types of liquid crystal effects. In addition, the display may be based on electrophoretic or electromechanical effects.

In the fluorescent light source mentioned in the opening paragraph, customarily a tubular low-pressure mercury-vapour discharge lamp, for example one or more cold-cathode fluorescent (CCFL), hot-cathode fluorescent lamps HCFL), or external electrode fluorescent lamps (EEFL) may be employed as discharge lamps in the illumination system. Commonly, a phosphorous coating is applied for allowing low-pressure mercury vapour discharge lamps being able to convert UV light to other wavelengths, for example, to UV-B light and UV-A light for tanning purposes (sun panel lamps) or to visible radiation for general illumination purposes. Such discharge lamps are therefore also referred to as fluorescent lamps.

An advantageous option for a backlight for a display device, such as an LCD, is the use of an array of small CCFL or EEFL lamps. In a particular application these lamps are formed together between two glass panels between which panels ribs are applied thereby defining the separate discharge vessels of the lamps. The diameter of each lamps is typically about 3 millimetre. In order to fulfil brightness specifications of the LCD it is important to use a large number of lamps, typically 80, which are typically on 4-35% of the time in case of scrolling backlighting. The performance of such an array of multiple small lamps is much better in terms of picture quality and size (thickness) compared to existing solutions with approximately 2-20 relatively large standard CCFL, EEFL or HCFL lamps.

During manufacturing of the small lamps army, the lamps have to be evacuated firstly, after which these lamps are filled with a certain mixture (ionisable) gases comprising mercury. A known solution to do this for the whole panel at once and to get an equal filling for each lamp is to physically make a gas connection between the individual (neighbouring) lamps, resulting in effectively one compartment of gases. This physical connection is also known as ‘pumping channel’. However if a voltage difference exists between two lamps during lamp operation across such a pumping channel an unwanted light emitting plasma may occur in that channel.

It is an object of the invention to provide an improved illumination system with which generation of a light emitting plasma within the pumping channel can be counteracted.

The object can be achieved by providing an illumination system according to the preamble, characterized in that the illumination system further comprises driving means for applying an electrical voltage on the electrodes of the lamps, said electrical voltage being selectively divided among the first electrodes on one side and the second electrodes on the other side, wherein at least in the vicinity of said channel substantially no voltage difference is present between neighbouring lamps. By selectively dividing the electrical (commonly alternating) voltage among the electrodes, in the vicinity of the channel a voltage difference between neighbouring lamps can be applied which is substantially equal to zero, as a result of which no light emitting plasma can and will be generated within said channel. The driving means preferably comprises capacitive ballasts, said ballasts being split up in two ballast portions, each ballast portion being adapted to drive a specific group of electrodes (either the first electrodes or the second electrodes). That means that each fluorescent lamp has preferably two capacitors in series. The advantage of splitting the driver in two ballast portions each for each side of the lamps is that the high-frequency (e.g. 10-150 kHz) high-voltage (order of 500-2 kV) connections to the lamps are as short as possible to prevent Electro Magnetic Interference (EMI). To eliminate the risk of generation of a light emitting plasma within the channel, the voltage difference between neighbouring lamps within the channel is preferably equal to zero. However, the absolute voltages within that channel of each lamp may have a certain value (other than zero), provided that there is no (substantially) voltage difference between the (neighbouring) lamps connected to said channel. Though, in a particular preferred embodiment a location of zero voltage is imposed to be in the vicinity, and preferably substantially within, the (pumping) channel, as a result of which the absolute voltages in each lamp at the location of the channel, and hence the voltage difference within that channel, can be minimised, thereby more reliably preventing generation of a light emitting plasma within said channel.

In a preferred embodiment more than two, and more preferably eighty, fluorescent lamps are connected together by means of said channel. By connecting multiple, in particular more than two, lamps to a pumping channel, the production process of the illumination system according to the invention can be facilitated significantly, since both emptying and subsequent filling of the different lamps can be performed relatively efficiently and quickly.

Notwithstanding the fact that a relatively uniform illumination of a display device can be achieved in a relatively effective manner by way of the embodiments described above still a further disadvantage can occur while displaying images on the display device. When relatively fast moving image material is displayed on a display device, such as an active matrix LCD, the picture sometimes becomes blurred because of the so-called “sample and hold” effect and the slow response of the LC pixels. A scanning backlight creates a stroke of light that scrolls with the same speed of the row-addressing speed from top to bottom of the screen and reduces motion blur significantly, however not completely. To this end, the illumination system preferably comprises multiple lamp sections, each section containing multiple fluorescent lamps, wherein the lamps of each section are connected together by means of a distinctive channel. In this manner, the sections can be switched row-wise on and off to improve the image quality displayed by the display device, such as an LCD. However, in practice it will be preferred to apply multiple sections of lamps, in particular eight sections of each ten lamps, wherein the lamps of all sections are mutually connected by means of a (single) common channel.

In order to situate the location of zero voltage substantially within, or at least within the vicinity of the channel, the channel is preferably situated at a predetermined position between the electrodes, preferably substantially centrally (in the middle) between the electrodes. By positioning the channel in the middle of the lamps, the lamps can be driven symmetrically, wherein the voltages applied to the first electrode(s) and the second electrode(s) are in the proportion of 1 to 1. However, for a person skilled in the art it may also be conceivable to impose other ratios for the voltages of the first electrode(s) respectively the second electrode(s), such as 2 to 1, 3 to 1, 1 to 2 and 3 to 1, or any other ratio based on whole or fractional numbers. In this latter case, the lamps are no longer driven symmetrically, as a result of which the (pumping) channel is preferably no longer positioned in the middle of the lamps.

Although different types of lamps may be used for the illumination system according to the invention, preferably the fluorescent lamps are formed by cold cathode fluorescent lamps (CCFL). Application of CCFL lamps is commonly advantageous, since these lamps generate merely a minor amount of heat, as a result of which a relatively large degree of freedom of design can be achieved by application of this type of lamps.

Conventional lamps of all types may be used for the illumination system according to the invention. However, preferably, the illumination system comprises a light emission window for emitting light in the direction of a display device, and a backing substrate at least a part of which backing substrate is arranged substantially opposite to the light emission window, wherein between said light emission window and said backing substrate ribs are provided, said ribs being arranged substantially in a parallel direction to define the discharge spaces of the fluorescent lamps, wherein at least one rib is provided with a connect opening thereby defining the channel connecting neighbouring discharge spaces. Preferably the ribs are connected to, and more preferably the ribs are an integral part of the light emission window to facilitate the manufacturing process of the illumination system. As mentioned afore with such an array of (small) lamps a relatively good picture quality and size (thickness) can be achieved with respect to conventional separate fluorescent lamps.

The invention also relates to a display device comprising an illumination system according to the invention. Besides Liquid Crystal Displays (LCD) all kinds of displays can be used which require active illumination by an external illumination system according to the invention. However, it must be clear that the illumination system may also be used for other purposes. To this end, the illumination system may for example also be used for direct lighting, or may be applied in light boxes or as part of tanning equipment.

The invention can further be illustrated by way of the following non-limitative embodiments, wherein:

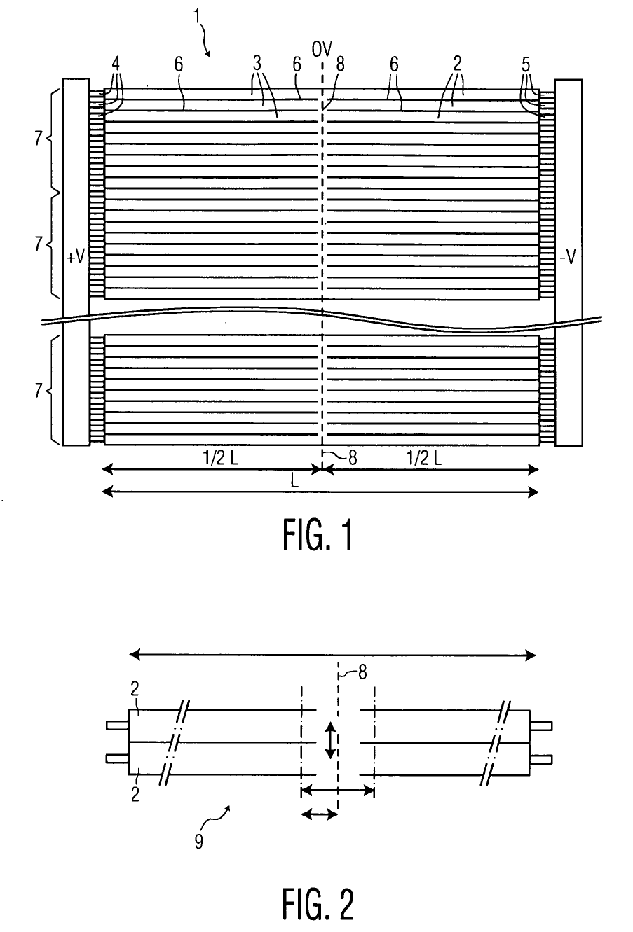

FIG. 1 shows a top view of an illumination system according to the invention, and

FIG. 2 shows a schematic view of a detail of the illumination system according to FIG. 1.

FIG. 1 shows a top view of an illumination system 1 according to the invention. The illumination system 1 comprises 80 lamps 2 of the CCFL type. Each lamp 2 comprises a discharge space 3, a first electrode 4, and a second electrode 5 positioned opposite to the first electrode 4. To this end, the illumination system 1 comprises two plates (not shown) between which ribs 6 are provided thereby defining the multiple neighbouring discharge spaces 3. Each section 7 of 10 neighbouring lamps 2, in particular neighbouring discharge spaces 3, is mutually coupled via a channel 8 for facilitated evacuating and subsequent filling of these lamp sections 7. In the embodiment shown 8 lamp sections 7 are present. During operation of the illumination system 1 the lamp sections 7 are switched on and off row-wise to generate a scrolling backlight illumination for a display device, in particular an LCD. However, in practice preference may be given to apply multiple sections 7 as stated above, though wherein said sections 7, and in particular the lamps 2 of all sections 7, are mutually connected by means of a single, joint channel (not shown). The channel 8 is positioned symmetrically between the first electrode(s) 4 and the second electrode(s) 5 respectively. To prevent generation of a light emitting plasma within said channel 8 due to a sufficient voltage difference between two lamps 2 of a section 7 the lamps 2 are driven such that a positive voltage of half the lamp voltage is applied to the first electrodes 4, and that a negative voltage of half the lamp voltage is applied to the second electrodes 5, as a result of which a zero voltage area is present within said channel 8. Since no voltage is present within the channel 8 no light emitting plasma will be generated within said channel 8. It is noted that in practice, an alternating voltage will be applied to the lamps 2. However, for simplicity reasons merely an instantaneous view, wherein a positive voltage is applied to the first electrodes 4 and a negative voltage is applied to the second electrodes 5, is depicted in this figure.

FIG. 2 shows a schematic view of a detail of the illumination system 9 according to FIG. 1. In the embodiment shown the voltage applied to the lamp (Vₗₐₘₚ) is 500 V. The length (Lₗₐₘₚ) is 650 mm. Hence, generation of a light emitting plasma will occur at an electric field (Eₚₗₐₛₘₐ) of 500/650=0.77 V/mm. The thickness of the ribs 6 (d_{rib}) is 0.5 mm. For this reason the voltage difference between neighbouring lamps 2 required for generating a light emitting plasma (ΔVₚₗₐₛₘₐ) is defined as:

$$Δ {V}_{plasma} = {d}_{rib} \cdot {E}_{plasma} = \frac{{d}_{rib } \cdot {V}_{lamp}}{{L}_{lamp}}$$

By shifting the zero voltage area with respect to (centre of) the channel 8 the voltage difference between the lamps 2 (ΔV_{shift}) is also shifted. This voltage shift can be defined as follows:

$$Δ {V}_{shift} = \frac{{d}_{shift} \cdot Δ {V}_{lamps}}{{L}_{lamp}}$$

Generation of a light emitting plasma can merely be prevented if the following condition is met:

ΔV_{shift}<ΔVₚₗₐₛₘₐ

By using this expression the maximum shift (d_{shift}) can be determined.

$$\frac{{d}_{shift} \cdot Δ {V}_{lamps}}{{L}_{lamp }} < \frac{{d}_{rib} \cdot {V}_{lamp}}{{L}_{lamp}}$$

$${d}_{shift} < {d}_{rib} \cdot \frac{{V}_{lamp}}{Δ {V}_{lamps }}$$

ΔVₗₐₘₚₛ can be considered as being a voltage asymmetry between neighbouring lamp voltages, which can be defined as follows:

ΔVₗₐₘₚₛ=Kₐₛ·Vₗₐₘₚ

wherein Kₐₛ is a factor representing the voltage asymmetry between neighbouring lamps 2. Finally the maximum shift (d_{shift}) can be determined by:

$${d}_{shift} < {d}_{rib} \cdot \frac{{V}_{lamp}}{{K}_{as} \cdot {V}_{lamp}}$$

$${d}_{shift} < \frac{{d}_{rib}}{{K}_{as}}$$

In case of a typical voltage asymmetry of 5%, d_{shift} comes to 0.5/0.05=10 mm. This means that the zero voltage (line) must be in the vicinity of the channel 8, such that the mutual distance between the zero voltage (line) and the channel 8 does not exceed +10 mm or −10 mm to prevent generation of a light emitting plasma within said channel 8.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. Illumination system for illuminating display devices, comprising:
a plurality of fluorescent lamps, each fluorescent lamp comprising:
an at least partially light-transmissive elongated discharge vessel filled with an ionisable substance, and
a first electrode and a second electrode connected to said vessel, between which electrodes a discharge extends during lamp operation,
wherein the discharge vessels of at least two lamps are mutually coupled by means of at least one channel, said channel being positioned at a distance of the electrodes of said lamps, characterized in that
the illumination system further comprises driving means for applying an electrical voltage on the electrodes of the lamps, said electrical voltage being selectively divided among the first electrodes on one side and the second electrodes on the other side, wherein at least in the vicinity of said channel substantially no voltage difference is present between neighbouring lamps.

2. System according to claim 1, characterized in that substantially no voltage difference between neighbouring lamps is present within said channel.

3. System according to claim 1 or 2, characterized in that a location of zero voltage is positioned in the vicinity of said channel.

4. System according to claim 3, characterized in that the location of zero voltage is positioned within said channel.

5. System according to claim 1, characterized in that more than two, preferably eighty, fluorescent lamps are connected together by means of said channel.

6. System according to claim 1, characterized in that the illumination system comprises multiple lamp sections, each section containing multiple fluorescent lamps, wherein the lamps of each section are connected together by means of a distinctive channel.

7. System according to claim 1, characterized in that the illumination system comprises multiple lamp sections, each section containing multiple fluorescent lamps, wherein the lamps of all sections are connected together by means of a common channel.

8. System according to one claim 1, characterized in that the channel is situated at a predetermined position between the electrodes, preferably substantially centrally between the electrodes.

9. System according to one of claim 1, characterized in that the fluorescent lamps are formed by cold cathode fluorescent lamps (CCFL).

10. System according to claim 1, characterized in that the illumination system further comprises a light emission window for emitting light in the direction of a display device, and a backing substrate at least a part of which backing substrate is arranged substantially opposite to the light emission window, wherein between said light emission window and said backing substrate ribs are provided, said ribs being arranged substantially in a parallel direction to define the discharge spaces of the fluorescent lamps, wherein at least one rib is provided with a connect opening thereby defining the channel connecting neighbouring discharge spaces.

11. Display device comprising an illumination system as claimed in one of the claims 1-10.
